(19) United States
(12) Patent Application Publication
(10) Pub. No.: US 2017/0019320 A1
(43) Pub. Date: Jan. 19, 2017

(54) INFORMATION PROCESSING DEVICE AND DATA CENTER SYSTEM

(71) Applicant: FUJITSU LIMITED, Kawasaki-shi (JP)

(72) Inventors: Kaname Takaochi, Hachioji (JP); Akito YAMAZAKI, Kawasaki (JP); Masanori Kimura, Mishima (JP); KEI OHISHI, CHIGASAKI (JP)

(73) Assignee: FUJITSU LIMITED, Kawasaki-shi (JP)

(21) Appl. No.: 15/182,653

(22) Filed: Jun. 15, 2016

(30) Foreign Application Priority Data
Jul. 15, 2015 (JP) 2015-141642

(51) Int. Cl. H04L 12/26; H04L 29/08

(52) U.S. Cl. CPC H04L 43/0858; H04L 67/1097

(57) ABSTRACT

A calculation unit calculates a priority for investigating each of a plurality of services operated by a first system and a second system that is a cluster configuration and is divided into a plurality of nodes in a plurality of data center, when the services are handed over from the first system to the second system, based on a degree of influence on a client device that uses the services and a degree of importance of each of the services. An output unit outputs the calculated priority.

### CROSS-REFERENCE TO RELATED APPLICATIONS

This application is based upon and claims the benefit of priority of the prior Japanese Patent Application No. 2015-141642, filed on Jul. 15, 2015, the entire contents of which are incorporated herein by reference.

### FIELD

The embodiments discussed herein are related to an information processing device, a computer-readable recording medium, and a data center system.

### BACKGROUND

In recent years, with the spread of cloud computing, cloud vendors who provide clouds have been developing data centers in a plurality of geographically distant regions, such as in different countries and cities. Each of the data centers is provided with a large number of physical servers and a large number of virtual machines that run on each of the physical servers. A system for the service of a cloud user who provides the service through the cloud is operated on the physical server or the virtual server. From the perspective of business continuity, and to take measures against natural disasters and the like, some cloud users configure the system in the data centers located in different regions in a high availability (HA) cluster. Conventional examples are described in Japanese Laid-open Patent Publication No. 2013-3896, Japanese Laid-open Patent Publication No. 2009-181536, and Japanese Laid-open Patent Publication No. 2003-241999.

To manage and operate the data centers effectively, a cloud vendor may provide a single control center, and the data centers are integrally managed and operated by the control center.

However, if the data centers are managed and operated by the single control center, the following problem may arise. For example, if a problem occurs in a data center, investigation requests are sent to the control center from a large number of cloud users who are operating the systems on the physical server or the virtual server on which the problem has occurred. Upon receiving a large number of investigation requests, the person in charge of the control center investigates the problem in the order of priority. However, there are times it is difficult to effectively determine the investigation priority of the problem. In particular, if the cloud user is using the HA cluster configuration, the system extends over the multiple data centers. Thus, it is difficult for the person in charge of the control center to determine the investigation priority of the problem. Hence, there are times it is difficult for the person in charge of the control center to determine which cloud user is to be given a priority. Consequently, it is difficult to deal with the problem effectively.

### SUMMARY

According to an aspect of an embodiment, an information processing device includes: a calculation unit that calculates a priority for investigating each of a plurality of services based on a degree of influence on a client device that uses the plurality of services handed over from a first system to a second system in a cluster configuration and a degree of importance of each of the services, the plurality of services being divided into a plurality of nodes in a plurality of data centers and operated by the cluster configuration including the first system and the second system; and an output unit that outputs the priority calculated by the calculation unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of a data center system according to an embodiment;

FIG. 2 is a diagram illustrating a functional configuration of a data center according to the embodiment;

FIG. 3 is a diagram illustrating a functional configuration of a control center according to the embodiment;

FIG. 4 is an exemplary diagram illustrating a data configuration of an operation policy table stored in an operation policy storage area;

FIG. 5 is an exemplary diagram illustrating a data configuration of a customer management table stored in a customer management information storage area;

FIG. 6 is an exemplary diagram illustrating a data configuration of an operation status table stored in an operation status information storage area;

FIG. 7 is an exemplary diagram illustrating a data configuration of a priority information table stored in a priority information storage area;

FIG. 8 is an exemplary diagram illustrating a flow of calculating priority;

FIG. 9 is a flowchart illustrating an example of a procedure of a priority calculation process; and

FIG. 10 is a diagram illustrating a computer that executes a computer program stored in a priority calculation program.

### DESCRIPTION OF EMBODIMENTS

Preferred embodiments of the present invention will be explained with reference to accompanying drawings. The embodiments are applicable to a data center system that includes a plurality of data centers provided with virtual machines. It is to be noted that the present invention is not limited to the embodiments. Further, the embodiments can be appropriately combined within a range that does not contradict the processing contents.

### [a] First Embodiment

Configuration of a Data Center System According to an Embodiment

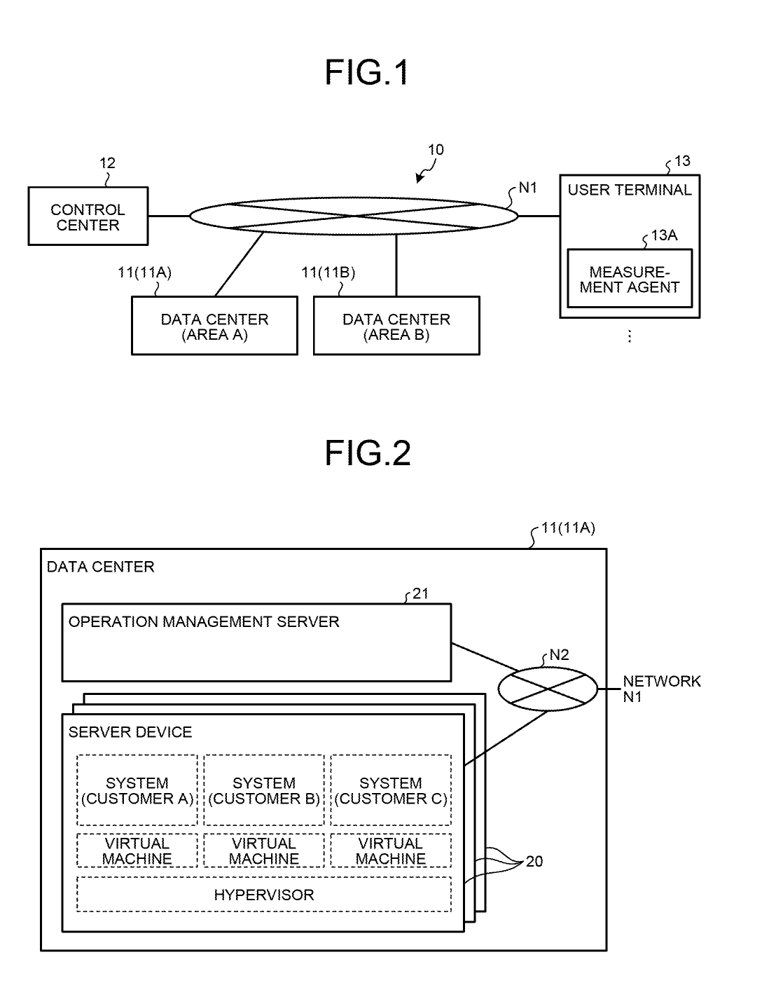

FIG. 1 is a diagram illustrating a hardware configuration of a data center system according to an embodiment. As illustrated in FIG. 1, a data center system 10 includes a plurality of data centers 11, and a control center 12. The data centers 11 and the control center 12 are connected with each other via a network N1. The network N1 may be a dedicated line or not. In the example in FIG. 1, there are two data centers 11 (11A and 11B). However, the number of the data centers 11 is optional, as long as there are equal to or more than two.

The data centers 11 are placed in geographically distant locations, so that even if an abnormality occurs on one of the data centers 11 due to a natural disaster or the like, the other data centers 11 will not be affected by the abnormality. In the present embodiment, it is assumed that the data centers 11 are placed in different areas, for example, in different countries or cities. For example, the data center 11A is placed in an area A. The data center 11B is placed in an area B. For example, the areas A and B may be countries such as a country A and a country B. For example, the areas A and B may also be geographically divided areas such as East Asia and North America.

In the data center system 10, a large number of physical servers and a large number of virtual machines (VM) that run on each of the physical servers are provided in the data centers 11 as nodes. The data center system 10 is divided into nodes of the data centers 11, and a plurality of services are operated in the HA cluster configuration. In the HA cluster configuration, the nodes of the data centers 11 are provided with the same program and data relative to each of the services, and the system for the service is made redundant. In the HA cluster configuration, the nodes of the data centers 11 are divided into a first system and a second system to be operated. The node in the first system is an active system node that provides a service according to a user's request, and on which the service is running. The node in the second system is a standby system node that is in a waiting state while the node in the first system is normally operated. When a problem such as a failure occurs on the node in the first system, the processing is handed over to the node in the second system for execution. In the data center system 10, a node in any one of the data centers 11 is used as an active system node, and a node in the other data center 11 is used as a standby system node, for each service. For example, a node of the data center 11 in the area A is an active system. A node of the data center 11 in the area B is a standby system. The programs and data related to the service are synchronized between the active system node and the standby system node, and the same programs and data relative to the service are stored in the active system node and the standby system node. A method for synchronizing data is optional. For example, the standby system node can perform mirroring with the active system node, so that the standby system node can store therein the same programs and data as those of the active system node. The active system node can transfer various requests and data to be processed to the standby system node, and when the standby system node executes the same processing as that of the active system node, the standby system node can store therein the same programs and same data as those of the active system node. If there are equal to or more than three data centers 11, for example, a node in one of the data centers 11 is the active system, and nodes in the other data centers 11 are the standby system. If a problem occurs in the active system node, in response to a predetermined handover policy, the processing is handed over to one of the standby system nodes, for each service.

A user terminal 13 of a user who uses the service operated in the data center system 10 is connected to the network N1. The example in FIG. 1 illustrates a single user terminal 13. However, the number of the user terminals 13 is optional.

The user terminal 13 is a client device that uses various services provided by the data centers 11. In the user terminal 13, a measurement agent 13A is operated, when a program in the measurement agent 13A is installed and executed. The measurement agent 13A communicates with the active system node and the standby system node of the service used by the user terminal 13, at a predetermined timing, and measures each communication time until the response has been received. For example, the measurement agent 13A transmits a test packet to the active system node and the standby system node, using a Packet Internet Groper (PING) and the like, and measures the time until the response is received. The predetermined timing, for example, may be any timing such as at a certain interval like every 10 minutes, when a predetermined time is reached, and when the system is handed over from the active system to the standby system. Thus, the response time is from when a test packet is transmitted to the active system node and the standby system node until the response is received. The measurement agent 13A then transmits response time information to the control center 12.

The control center 12 integrally manages and operates the data centers 11. For example, the control center 12 identifies the state of the node running in the data centers 11. When a problem occurs, the control center 12 investigates and deals with the problem, upon receiving an investigation request from a cloud user who provides the service. The control center 12 may be integrated with one of the data centers 11.

Hardware Configuration of Data Center

Next, a functional configuration of the data center 11 will be described with reference to FIG. 2. FIG. 2 is a diagram illustrating the functional configuration of the data center according to the embodiment. It is to be noted that the functional configurations of the data centers 11A and 11B are substantially the same. Thus, in the following, the configuration of the data center 11A will be described as an example.

The data center 11 includes a plurality of server devices 20 and an operation management server 21. The server devices 20 and the operation management server 21 are communicatively connected via a network N2. The network N2 is communicatively connected to the network N1, and communicable with the other data centers 11 via the network N1. The example in FIG. 2 illustrates three server devices 20. However, the number of the server devices 20 is optional. In addition, the example in FIG. 2 illustrates a single operation management server 21. However, the number of the operation management servers 21 may be equal to or more than two.

Each of the server devices 20 is a physical server that provides various services to a user, by operating a virtual machine that is a virtual computer. For example, the server device 20 may be a server computer. By executing a server virtualization program, the server device 20 operates the virtual machines on a hypervisor, and operates an application program corresponding to the service provided by a cloud user on the virtual machine. Thus, the server device 20 operates the system for the service. In the present embodiment, the system of a customer such as a company is operated as the system of the cloud user. In the example in FIG. 2, systems of a customer A, a customer B, and a customer C are operated as systems of the cloud users. The systems of the customer A, the customer B, and the customer C are made redundant, by configuring the HA cluster with the data center 11B. In the present embodiment, the systems of the customer A, the customer B, and the customer C of the data center 11A illustrated in FIG. 2 are active systems, and the systems of the customer A, the customer B, and the customer C of the data center 11B are standby systems. When a problem occurs in the systems of the customer A, the customer B, and the customer C of the data center 11A, the processing shifts to the systems of the customer A, the customer B, and the customer C of the data center 11B. Thus, even if a problem occurs in the systems of the customer A, the customer B, and the customer C as well as the data center 11A, the service provided by the systems of the customer A, the customer B, and the customer C, can be continuously provided to the user terminal 13.

The operation management server 21 is a physical server that operates and manages the data centers 11. For example, the operation management server 21 may be a server computer. For example, the operation management server 21 collects information from the server devices 20 and the virtual machines that operate on the respective server devices 20 in the data centers 11, and manages the operation status thereof. The operation management server 21 then notifies the control center 12 of the operation status of the server devices 20 and the virtual machines. In addition, the operation management server 21 outputs various instructions to the server devices 20 and the virtual machines, corresponding to various instructions from the control center 12. In the HA cluster configuration, the active system node and the standby system node regularly transmit and receive packets with each other, to confirm the live status and the operation status thereof. For example, the active system node and the standby system node are interconnected, and regularly transmit and receive packets. In the active system node or the standby system node, the time from when a packet is transmitted to the correspondent node until a response is received, is measured. The operation management server 21 collects the measured time from the active system node or the standby system node, for each system of the cloud user, as the communication time between the active system node and the standby system node. The operation management server 21 then transmits communication time information to the control center 12. In the data center system 10, the operation management server 21 of any one of the data centers 11 may be operated as a management server that manages the entire data center system 10. In this case, the operation management server 21 of the other data center 11 notifies the operation management server 21, which is set as the management server that manages the entire data center system 10, of the status in the data centers 11.

Hardware Configuration of Control Center

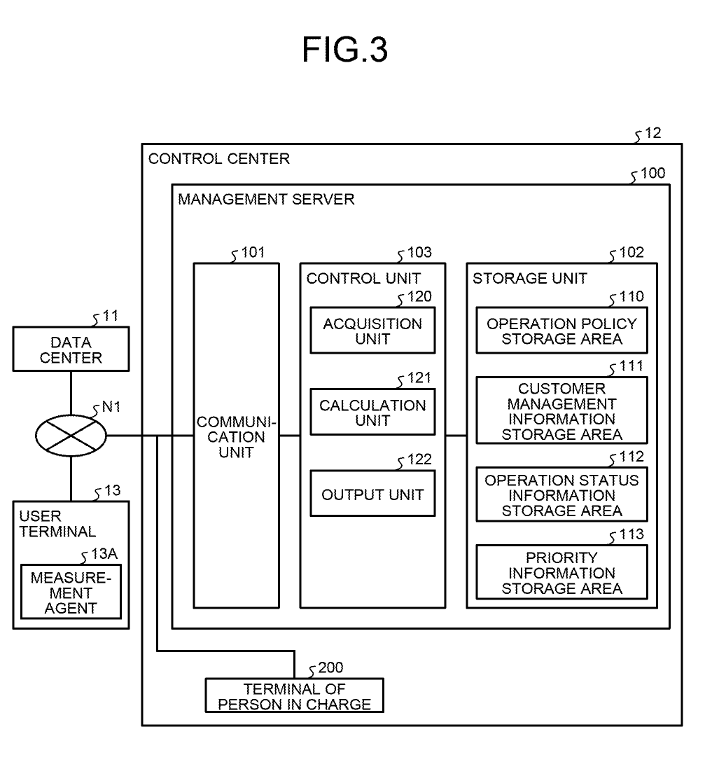

A functional configuration of the control center 12 will now be described with reference to FIG. 3. FIG. 3 is a diagram illustrating the functional configuration of the control center according to the embodiment.

The control center 12 includes a management server 100 and a terminal of a person in charge 200. The management server 100 and the terminal of the person in charge 200, for example, are communicatively connected with a network in the control center 12. The network in the control center 12 is communicatively connected with the network N1, and is communicable with the data centers 11 via the network N1. The example in FIG. 3 illustrates a single management server 100. However, the number of the management servers 100 may be equal to or more than two.

The management server 100 is an information processing device that integrally manages and operates the data centers 11, based on the information notified by the operation management server 21 of the data centers 11. For example, the management server 100 may be a server computer. If a problem such as a failure occurs in one of the data centers 11, the management server 100 analyzes the status, and specifies the service affected by the problem. In addition, the management server 100 calculates a priority for dealing with a problem for each service affected by the problem, according to the request from the terminal of the person in charge 200, and outputs the result to the terminal of the person in charge 200.

For example, the terminal of the person in charge 200 is implemented by a desk top personal computer (PC), a note-type PC, a tablet terminal, a mobile phone, a personal digital assistant (PDA), and the like. For example, a person in charge of troubleshooting uses the terminal of the person in charge 200.

Configuration of Management Server (Information Processing Device)

A configuration of the management server 100 according to the first embodiment will now be described. As illustrated in FIG. 3, the management server 100 includes a communication unit 101, a storage unit 102, and a control unit 103. It is to be understood that the management server 100 may include various functional units included in a known computer, in addition to the functional units illustrated in FIG. 3. For example, the management server 100 may include a display unit that displays various types of information, and an input unit that inputs various types of information.

For example, the communication unit 101 is implemented with a network interface card (NIC). For example, the communication unit 101 is connected with the network N1 in a wired or wireless manner. The communication unit 101 transmits and receives information to and from the data centers 11, via the network N1. For example, the communication unit 101 transmits and receives information to and from the terminal of the person in charge 200, via the network in the control center 12.

The storage unit 102 is a storage device such as a hard disk, a solid state drive (SSD), and an optical disk. The storage unit 102 may also be a data rewritable semiconductor memory such as a random access memory (RAM), a flash memory, and a non-volatile static random access memory (NVSRAM).

The storage unit 102 stores therein an operating system (OS) and various programs executed by the control unit 103. For example, the storage unit 102 stores therein various programs including a program that executes a priority calculation process, which will be described below. In addition, the storage unit 102 includes a storage area for storing various types of data used by the program executed by the control unit 103. The storage unit 102 in the present embodiment includes an operation policy storage area 110, a customer management information storage area 111, an operation status information storage area 112, and a priority information storage area 113.

The operation policy storage area 110 is a storage area for storing an operation policy table in which various policies on operating the data center system 10 are defined. For example, the operation policy storage area 110 stores therein a policy on dealing with each cloud user who provides the service through the cloud, when a problem occurs. For example, the information in the operation policy table is set in advance by a person in charge of the control center 12 and the like. To the operator of the data center system 10, a cloud user is a customer who uses the data center system 10. Thus, in the following, the cloud user is also referred to as a “customer”. A user who uses the service provided by the cloud user is also referred to as an “end user”.

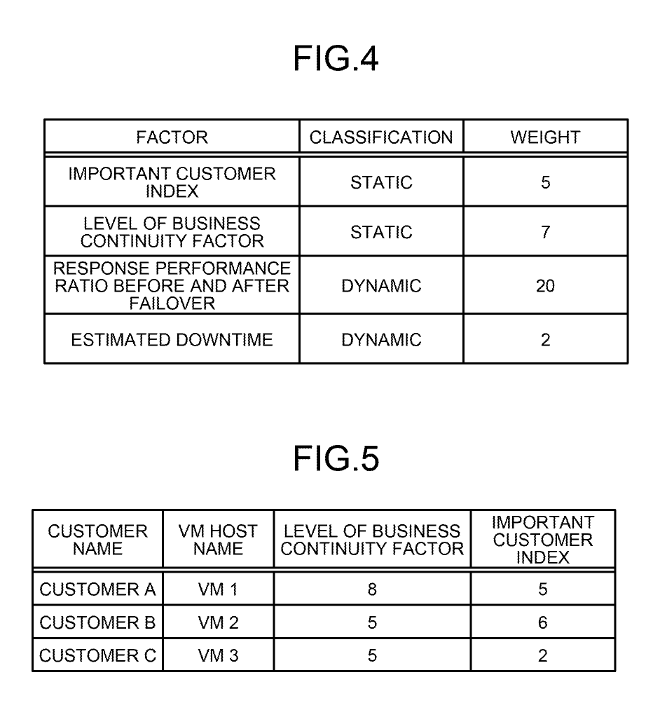

FIG. 4 is an exemplary diagram illustrating a data configuration of an operation policy table stored in an operation policy storage area. As illustrated in FIG. 4, the operation policy table has items such as a “factor”, “classification”, and “weight”.

The items of the factor are areas for storing a factor for defining the operation policy. The items of the classification are areas for storing the classification of the factor that defines the operation policy. In the present embodiment, the factor is classified into a predetermined static factor, and a dynamic factor that changes dynamically depending on the status of the data center system 10. If the factor is static, “static” is stored in the items of the factor, and if the factor is dynamic, “dynamic” is stored in the items of the factor. The items of weight are areas for storing a weighted value defined for each factor.

In the example in FIG. 4, the factor of an “important customer index” is a static factor, and the weighted value is “5”. The factor of a “level of a business continuity factor” is a static factor, and the weighted value is “7”. The factor of a “response performance ratio before and after failover” is a dynamic factor, and the weighted value is “20”. The factor of “estimated downtime” is a dynamic factor, and the weighted value is “2”.

Returning back to FIG. 3, the customer management information storage area 111 is a storage area for storing a customer management table in which various types of information on operating and managing customers are stored. For example, the customer management information storage area 111 stores therein the status of the system and the level of the operation policy for each customer at the time when a problem has occurred. For example, the pieces of the information on the customer management table is set in advance by the person in charge of the control center 12, and the like.

FIG. 5 is an exemplary diagram illustrating a data configuration of a customer management table stored in a customer management information storage area. As illustrated in FIG. 5, the customer management table includes items such as a “customer name”, a “VM host name”, a “level of business continuity factor”, and an “important customer index”. The values of the factors of the static priority are all defined in the customer management table.

The items of the customer name are areas for storing identification information for identifying a customer. The items of the VM host name are areas for storing identification information of a virtual machine on which the active system of the customer is operated. Each virtual machine is defined with a unique virtual machine name as identification information. The items of the VM host name store therein the name of a virtual machine on which the active system of the customer is operated. The items of the level of business continuity factor are areas for storing priority level defined for the system of the customer, when a problem occurs. The items of the important customer index are areas for storing the priority level defined for the customer. In the priority level, it is assumed that the degree of priority is higher as the value is increased.

In the example in FIG. 5, with the cloud user “customer A”, the active system is operating on a virtual machine having the name “VM 1”, the level of business continuity factor is “8”, and the important customer index is “5”. With the cloud user “customer B”, the active system is operating on a virtual machine having the name “VM 2”, the level of business continuity factor is “5”, and the important customer index is “6”. With the cloud user “customer C”, the active system is operating on a virtual machine having the name “VM 3”, the level of business continuity factor is “5”, and the important customer index is “2”.

Returning back to FIG. 3, the operation status information storage area 112 is a storage area for storing therein an operation status table for storing therein various types of information related to the operation status, when a failover occurs and the system is handed over from the active system to the standby system due to a problem. For example, the operation status information storage area 112 stores therein information related to the virtual machine to which the system is handed over due to the failover, and information related to the performance change due to the handover of the system. A calculation unit 121, which will be described below, sets the pieces of information on the operation status table. It is expected that the values of the factors of the dynamic priority are all defined in the operation status table.

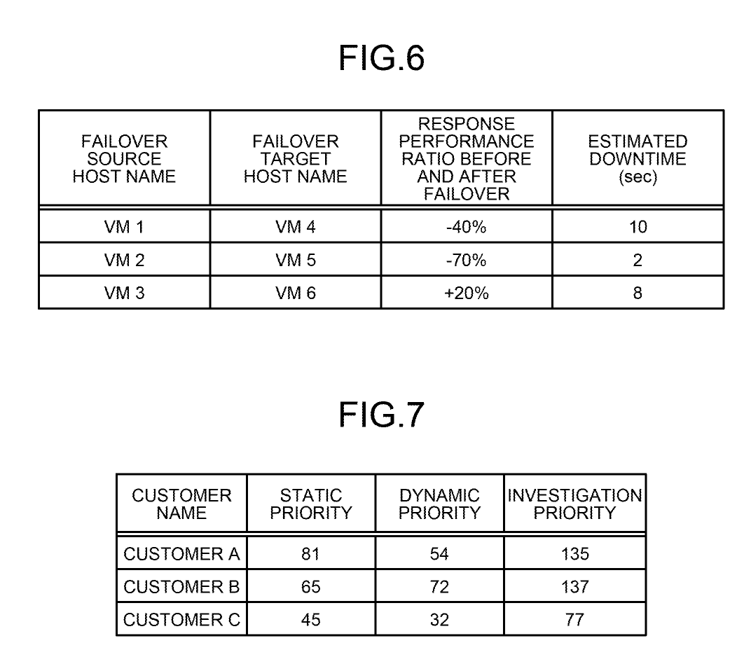

FIG. 6 is an exemplary diagram illustrating a data configuration of an operation status table stored in an operation status information storage area. As illustrated in FIG. 6, the operation status table includes items such as a “failover source host name”, a “failover target host name”, a “response performance ratio before and after failover”, and “estimated downtime”.

The items of the failover source host name are areas for storing the name of the virtual machine being an active system at the time of the failover. The items of the failover target host name are areas for storing therein the name of the virtual machine being a standby system at the time of the failover. The items of the response performance ratio before and after failover are areas for storing the changed degree of the response performance of the system, due to the failover. In the present embodiment, the response performance ratio before and after failover is indicated in percentage (%). The response performance ratio before and after the failover is the change rate of the response performance of the system after the failover, relative to the response performance of the system before the failover. The items of the estimated downtime are areas for storing the time during which the system is unable to respond due to the failover, and are indicated in seconds [sec].

In the example in FIG. 6, if a failover occurs from the virtual machine having the name “VM 1” to the virtual machine having the name “VM 4”, the performance is reduced by 40%, and the downtime during which the system is unable to respond is “10” seconds. In addition, if a failover occurs from the virtual machine having the name “VM 2” to the virtual machine having the name “VM 5”, the performance is reduced by 70%, and the downtime during which the system is unable respond is “2” seconds. Further, if a failover occurs from the virtual machine having the name “VM 3” to the virtual machine having the name “VM 6”, the performance is increased by 20%, and the downtime during which the system is unable to respond is “8” seconds.

Returning to FIG. 3, the priority information storage area 113 is a storage area for storing therein a priority information table that stores therein various types of information related to the degree of a priority for dealing with a problem for each customer, when a problem occurs. For example, the priority information storage area 113 stores therein various types of priorities calculated for each customer. The various types of information in the priority information table are to be set by the calculation unit 121, which will be described below.

FIG. 7 is an exemplary diagram illustrating a data configuration of a priority information table stored in a priority information storage area. As illustrated in FIG. 7, the priority information table includes items such as a “customer name”, a “static priority”, a “dynamic priority”, and an “investigation priority”.

The items of the customer name are areas for storing therein identification information for identifying a customer. The items of the static priority are areas for storing therein the static priority calculated from the information determined in advance for the cloud user. The static priority indicates the degree of importance of the service provided by the customer. The items of the dynamic priority are areas for storing the dynamic priority calculated from the information related to the performance change of the system, due to the failover. The dynamic priority indicates a degree of influence on the user terminal 13, when the service provided by the customer is handed over from the active system to the standby system, due to the failover. The items of the investigation priority are areas for storing the investigation priority and the priority for dealing with a problem, for each system.

In the example in FIG. 7, with the cloud user “customer A”, the static priority is “81”, the dynamic priority is “54”, and the investigation priority is “135”. With the cloud user “customer B”, the static priority is “65”, the dynamic priority is “72”, and the investigation priority is “137”. With the cloud user “customer C”, the static priority is “45”, the dynamic priority is “32”, and the investigation priority is “77”.

Returning back to FIG. 3, the control unit 103 is a device that controls the management server 100. The control unit 103 may be an electronic circuit such as a central processing unit (CPU) and a micro processing unit (MPU). The control unit 103 may also be an integrated circuit such as an application specific integrated circuit (ASIC), a field programmable gate array (FGPA), and the like. The control unit 103 includes an internal memory that stores therein programs and control data in which various processing procedures are defined. The control unit 103 executes various types of processing with the programs and control data. By operating the various programs, the control unit 103 functions as various processing units. For example, the control unit 103 includes an acquisition unit 120, a calculation unit 121, and an output unit 122.

The acquisition unit 120 acquires various types of data. For example, the acquisition unit 120 acquires response time information from the user terminal 13. The response time information may be transmitted, when the acquisition unit 120 transmits a request to the user terminal 13. In addition, the response time information may be transmitted at a regular timing such as when the user terminal 13 has measured the response time and the like. The acquisition unit 120 acquires communication time information from the operation management server 21 of the data centers 11. The communication time information may also be transmitted, when the acquisition unit 120 transmits a request to the operation management server 21 of the data centers 11, or at a regular timing such as when the operation management server 21 of the data centers 11 has measured the communication time.

The calculation unit 121 performs various calculations. For example, when the system for the service operated by the cluster configuration is handed over from the active system to the standby system, due to a problem and the like, the calculation unit 121 calculates the degree of influence on the user terminal 13 and the degree of importance of the service, for each service affected by the problem. The calculation unit 121 then calculates the priority for dealing with a problem from the degree of influence on the user terminal 13, and the degree of importance of the service, for each service.

First, a method of calculating a degree of importance of a service will be described. The calculation unit 121 calculates the degree of importance of the service, by weighting and adding each index in the customer management table with a weighted value of the static factor in the operation policy table, for each service. For example, with the service of the customer A illustrated in FIG. 5, if a failover occurs in the system for the service from the virtual machine having the name “VM 1” to the virtual machine having the name “VM 4” as illustrated in FIG. 6, the calculation unit 121 calculates the degree of importance of the service as below. The calculation unit 121 performs weighting by multiplying the value “8” of the level of business continuity factor by the weighted value “7” of the level of business continuity factor. The calculation unit 121 also performs weighting by multiplying the important customer index “5” by the weighted value “5” of the important customer index. The calculation unit 121 then calculates the degree of importance of the service, by adding the weighted values.

Degree of importance of service=8×7+5×5=81

The degree of importance of the service is calculated from the level of business continuity factor and the important customer index determined in advance. Thus, it does not change by the status of the system, and it is a static value.

Next, a method of calculating a degree of influence on the user terminal 13 will be described. The calculation unit 121 specifies a response time between the user terminal 13 and the active system node as well as a response time between the user terminal 13 and the standby system node, from the response time information acquired by the acquisition unit 120, for each of the services the system is handed over from the active system to the standby system. The calculation unit 121 then calculates a response time change rate of the user terminal 13, when the system is handed over from the active system to the standby system. For example, the calculation unit 121 calculates the response time change rate, using the following formula (1).

Change rate of response time [%]=[(T1/T2)−1]×100 (1)

In this example, T1 is the response time between the user terminal 13 and the active system node. T2 is the response time between the user terminal 13 and the standby system node.

The response time change rate indicates the changed degree of the response performance of the system relative to the user terminal 13, when the system executing the service is shifted from the active system node to the standby system node.

In addition, the calculation unit 121 specifies downtime that occurs when the system is handed over from the active system node to the standby system node, from the communication time information acquired by the acquisition unit 120, for each service handed over from the active system to the standby system. In this example, the programs and data relative to the service are synchronized between the standby system node and the active system node, and the same programs and data relative to the service are stored in the standby system node and the active system node. In this case, the active system node can be handed over to the standby system node, through the communication related to the handover between the active system node and the standby system node. Thus, the downtime during which both the active system node and the standby system node are not capable of responding to the service, is while the communication related to the handover is being carried out. In the present embodiment, the communication time between the active system node and the waiting system node is estimated as the downtime. The calculation unit 121 specifies the communication time between the active system node and the standby system node from the communication time information, for each service.

The calculation unit 121 generates an operation status table that stores therein the active system node, the standby system node, the response time change rate, and the communication time between the active system node and the standby system node, for each service that has been handed over from the active system to the standby system. The calculation unit 121 then stores the generated operation status table in the storage unit 102. As illustrated in the example in FIG. 6, the operation status table stores the fact that if a failover of the system for the service occurs from the virtual machine having the name “VM 1” to the virtual machine having the name “VM 4”, the response performance of the user terminal 13 is reduced by 40%, and the downtime is 10 seconds.

The calculation unit 121 calculates the degree of influence on the user terminal 13 of the service, by using the response time change rate and the downtime of the service, for each service that has been handed over from the active system to the standby system. For example, the calculation unit 121 calculates a correction value of the response performance ratio before and after failover, by using the following formula (2).

Correction value of response performance ratio before and after failover=1/[(RC+100)/100] (2)

In this formula, RC is the response time change rate (response performance ratio before and after failover).

Because the priority is increased with the deterioration of performance, the correction value of the response performance ratio before and after failover is an inverse to the response time change rate.

The calculation unit 121 calculates the degree of influence on the user terminal 13, by weighting and adding each of the correction value of the response performance ratio before and after failover, and the downtime, with the weighted value of a dynamic factor in the operation policy table.

For example, as illustrated in FIG. 6, if a failover of the system for the service occurs from the virtual machine having the name “VM 1” to the virtual machine having the name “VM 4”, the response time change rate is “−40%”. In this case, the correction value of the response performance ratio before and after failover is calculated as follows, using the formula (2) described above.

1/[(−40+100)/100]=1.666 . . . ≈1.67

As follows, the calculation unit 121 performs weighting by multiplying the correction value “1.67” of the response performance ratio before and after failover by the weighted value “20” of the response performance ratio before and after failover. The calculation unit 121 also performs weighting by multiplying the downtime “10” by the weighted value “2” of the estimated downtime. The calculation unit 121 then calculates the degree of influence on the user terminal 13, by adding the weighted values.

Degree of influence on the user terminal 13=1.67×20+10×2=54

The degree of influence on the user terminal 13 is calculated by the response time change rate in the user terminal 13 and the downtime. The response time change rate in the user terminal 13 and the downtime change dynamically, depending on the status of the system. Thus, the degree of influence on the user terminal 13 changes dynamically depending on the status of the system.

The calculation unit 121 stores the calculation results in the priority information table. For example, the calculation unit 121 stores the degree of importance of the service as the static priority, and the degree of influence on the user terminal 13 as the dynamic priority, in correlation with the customer name of the service, in the priority information table. The calculation unit 121 also stores the value obtained by adding the static priority and the dynamic priority, as the investigation priority, in the priority information table. In this manner, as illustrated in FIG. 7, the priority information table stores the fact that with the cloud user “customer A”, the static priority is “81”, the dynamic priority is “54”, and the investigation priority is “135”.

The output unit 122 outputs various contexts. For example, the output unit 122 outputs the priority, the degree of influence, and the degree of importance of the service calculated by the calculation unit 121 for each customer, to the terminal of the person in charge 200. For example, the output unit 122 makes the terminal of the person in charge 200 display the screen on which the information in the priority information table illustrated in FIG. 7 that is stored in the priority information storage area 113 is displayed. In the example in FIG. 7, the priority of the customer A is high when only the static priority is taken into consideration. However, when the dynamic priority is added, the investigation priority of the customer B is increased. As a result, the priority is preferably given in the order of the customer B, the customer A, and the customer C. In this manner, the priority added with the dynamic priority is output. Consequently, the priority for investigating the problem can be output, by giving a high value to the service that extends over the data centers and that has a large influence on the user terminal 13.

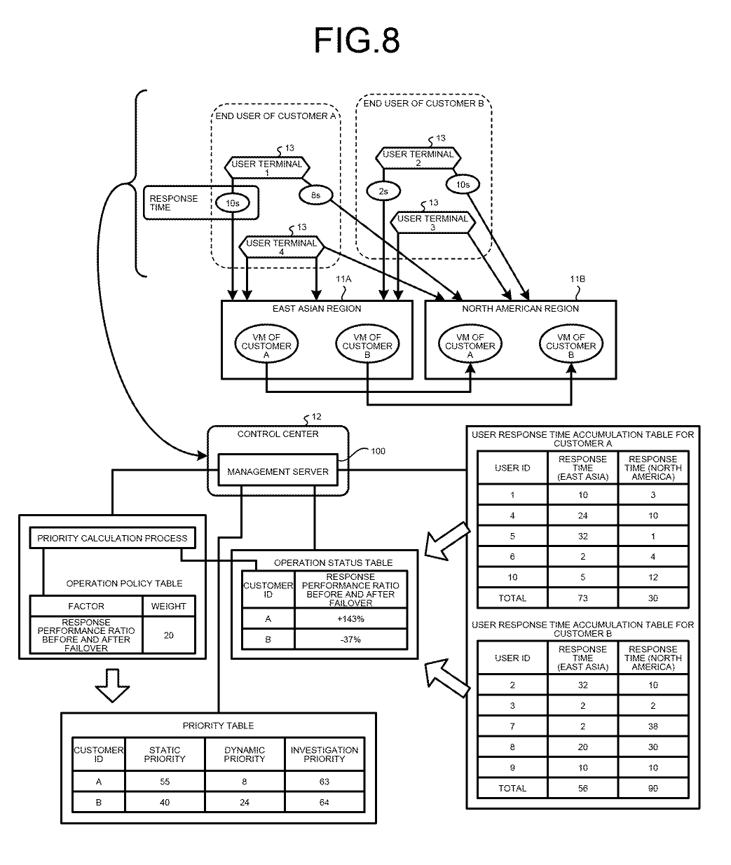

An example of a flow of calculating priority will now be described. FIG. 8 is an exemplary diagram illustrating a flow of calculating priority. In the example in FIG. 8, the systems for the services of the customer A and the customer B are configured in an HA cluster with the virtual machines (VMs), between the data center 11A in the East Asian region and the data center 11B in the North American region. The user terminal 13 of each end user of the customer A measures a response time between the virtual machine in the active system and the user terminal 13, as well as a response time between the virtual machine in the standby system and the user terminal 13, in the system of the customer A. The user terminal 13 then transmits the results to the management server 100 of the control center 12. In the example in FIG. 8, it is assumed that the response time between the virtual machine in the data center 11A and the user terminal 13 is 10 seconds, and the response time between the virtual machine in the data center 11B and the user terminal 13 is 8 seconds. In addition, the user terminal 13 of each end user of the customer B measures a response time between the virtual machine in the active system and the user terminal 13, as well as a response time between the virtual machine in the standby system and the user terminal 13, in the system of the customer B. The user terminal 13 then transmits the results to the management server 100 of the control center 12. In the example in FIG. 8, it is assumed that the response time between the virtual machine in the data center 11A and the user terminal 13 is 2 seconds, and the response time between the virtual machine in the data center 11B and the user terminal 13 is 38 seconds. The management server 100 stores therein the response time between the user terminal 13 and each of the data centers 11, for each system of the customer.

If a problem occurs in the data center 11A, the systems of the customer A and the customer B are shifted from the active system to the standby system. Because the systems of a large number of customers are running in the data centers 11, if a problem occurs in any one of the data center 11, investigation requests are sent to the control center 12 from a large number of customers.

The management server 100 calculates a priority for dealing with the problem, for each system of the customer, by performing the priority calculation process. For example, the management server 100 calculates the response time change rate, from the response time between the user terminal 13 and each of the data centers 11, for each system of the customer. For example, the management server 100 sums up the most recent response time between the user terminal 13 and each of the data centers 11, for each of the data centers 11. The management server 100 then calculates the response time change rate using the formula (1) described above, by setting the sum of the response time between the user terminal 13 and the active system node as T1, and the sum of the response time between the user terminal 13 and the standby system node as T2. In the example in FIG. 8, the response time change rate of the customer A is calculated as +143%(=[(73/30)−1]×100). The response time change rate of the customer B is calculated as −37%(=[(56/90)−1]×100). The example in FIG. 8 indicates that the response time change rate of the customer A is 143%, and the response time change rate of the customer B is −37%, as the response performance ratio before and after failover. The response time change rate may also be obtained from the response time between any one of the user terminals 13 and each of the data centers 11. For example, the response time change rate may also be obtained from the response time between the user terminal 13 and each of the data centers 11, measured within the latest predetermined period, such as within the last 30 minutes.

In the management server 100, a correction value of the response performance ratio before and after failover is obtained from the response time change rate, using the formula (2), for each system of the customer. The management server 100 then calculates the degree of influence on the user terminal 13, by weighting and adding the correction value of the response performance ratio before and after failover, with the downtime, which is not illustrated, for each system of the customer. The management server 100 also calculates the degree of importance of the service, by weighting and adding the value of the level of business continuity factor, which is not illustrated, with the value of the important customer index, for each system of the customer. The management server 100 further calculates a priority for dealing with a problem, from the degree of influence on the user terminal 13, and the degree of importance of the service. The example in FIG. 8 indicates that the degree of importance of the service of the customer A is 55, and the degree of importance of the service of the customer B is 40, as the static priority. In addition, the example in FIG. 8 indicates that the degree of influence on the user terminal 13 of the customer A is 8, and the degree of influence on the user terminal 13 of the customer B is 24, as the dynamic priority. Further, the example in FIG. 8 indicates that the priority of the customer A is 63, and the priority of the customer B is 64, as the investigation priority. From the priority being displayed, the person in charge of troubleshooting can determine which service of the customer is to be preferentially investigated and to be dealt with.

Processing Flow

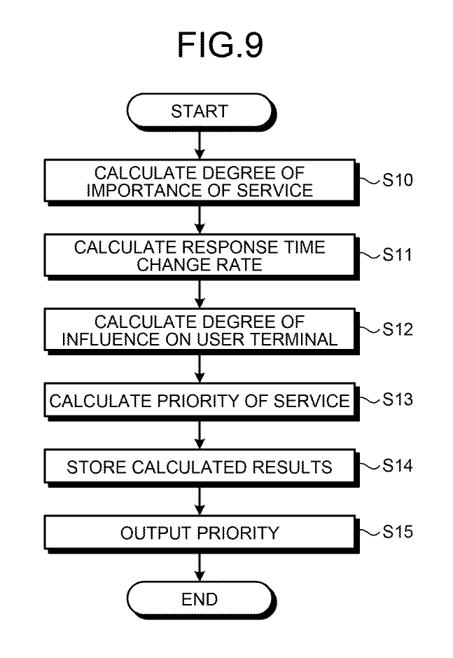

Next, a flow of the priority calculation process in which the management server 100 calculates a priority according to the first embodiment will be described. FIG. 9 is a flowchart illustrating an example of a procedure of a priority calculation process. The priority calculation process is executed at a predetermined timing, for example, at a timing when a request for displaying the priority is received from the terminal of the person in charge 200.

The calculation unit 121 calculates the degree of importance of the service, by adding a value obtained by multiplying the value of the level of business continuity factor by the weighted value of the level of the business continuity factor, with the value obtained by multiplying the value of the important customer index by the weighted value of the important customer index, for each service (S10).

The calculation unit 121 then calculates the response time change rate, from the response time of the active system node and the response time of the standby system node, for each service (S11). The calculation unit 121 then calculates the degree of influence on the user terminal 13 of the service, by using the response time change rate and the downtime of the service, for each service (S12).

The calculation unit 121 then calculates the priority of each service, by adding the value of the degree of importance of the service and the value of the degree of influence on the user terminal 13, for each service (S13). The calculation unit 121 then stores the calculated results in the priority information table (S14). The output unit 122 makes the terminal of the person in charge 200 to display the screen on which the information in the priority information table (S15) is displayed, and completes the process.

Advantageous Effects

As described above, the management server 100 calculates the degree of influence on the user terminal 13 that uses the services divided into the nodes in the data centers 11 and operated by the cluster configuration, when the services are handed over from the active system to the standby system. In addition, the management server 100 calculates the degree of importance of each of the services. The management server 100 further calculates the priority of each of the services, based on the degree of influence on the user terminal 13, and the degree of importance of each of the services. The management server 100 then outputs the calculated priority. In this manner, the management server 100 can effectively deal with the problem.

The management server 100 obtains response time information that indicates the response time between the user terminal 13 and the nodes in the data centers 11, as well as the communication time information that indicates the communication time between the nodes in the data centers. The management server 100 calculates the response time change rate from the response time between the user terminal 13 and the active system node as well as the response time between the user terminal 13 and the standby system node, indicated in the response time information, for each of the services. The management server 100 calculates the downtime of the service from the communication time between the nodes in the active system and the standby system. By using the response time change rate and the downtime of the service, the management server 100 calculates the degree of influence on the user terminal 13 of the service. Consequently, the management server 100 can calculate the degree of influence on the user terminal 13 of the service, when the system for the service is shifted between the data centers 11.

The management server 100 according to the present embodiment calculates the degree of importance of the service, from the priority level determined for the service as well as the priority level determined for the provider (cloud user) of the service, for each of the services. Consequently, the management server 100 can increase the degree of importance of the service, by increasing the priority level of the cloud user and the service that are to be preferentially dealt with.

The management server 100 according to the present embodiment outputs the degree of influence and the degree of importance in correlation with the priority. The person in charge of troubleshooting can investigate and deal with the problem, by determining the degree of influence on the user terminal 13 and the degree of importance of the service, from the degree of influence on the user terminal 13 and the degree of importance of the service being displayed. Thus, the management server 100 can effectively deal with the problem.

### [b] Second Embodiment

While the embodiment of the disclosed device has been described above, it is to be understood that various other modifications may be made to the disclosed technology, in addition to the embodiment described above. Hereinafter, another embodiment included in the present invention will be described.

For example, in the above-described embodiment, the degree of influence on the user terminal 13 is calculated from the response time between the user terminal 13 and the active system node, and the response time between the user terminal 13 and the standby system node, as well as the downtime. However, the disclosed device is not limited thereto. For example, the degree of influence on the user terminal 13 may also be calculated, by further weighting and adding the change rate of the number of times of processing, such as the network traffic between the active system node and the standby system node, the number of server accesses, and the number of database transactions.

In the embodiment described above, the priority is calculated, by adding the value of the degree of influence on the user terminal 13, and the value of the degree of importance of the service, for each service. However, the disclosed device is not limited thereto. For example, the priority may also be calculated using a predetermined calculation, such as by weighting and adding the value of the degree of influence on the user terminal 13 and the value of the degree of importance of the service, and the like.

The illustrated constituent elements of the devices are functionally conceptual, and need not be physically configured as illustrated. In other words, the specific mode of dispersion and integration of each device is not limited to the ones illustrated in the drawings, and all or a part thereof can be functionally or physically distributed or integrated in an optional unit, depending on various kinds of load and the status of use. For example, the processing units of the acquisition unit 120, the calculation unit 121, and the output unit 122 may be appropriately integrated. In addition, the process performed by each of the processing units may be appropriately divided into processes performed by a plurality of processing units. All or an optional part of the processing functions performed by the processing units may be implemented by a CPU and a computer program analyzed or executed by the CPU, or may be implemented as hardware by the wired logic.

Priority Calculation Program

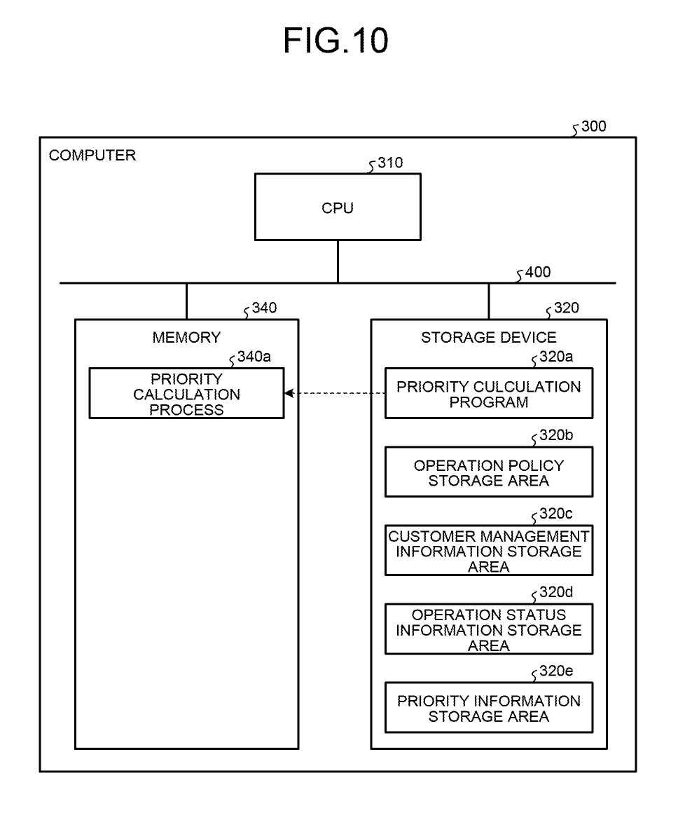

The various processes in the embodiments described above can also be implemented by executing prepared computer programs with a computer system such as a personal computer or a workstation. In the following, an example of a computer system that executes computer programs having functions similar to those in the embodiments described above will be explained. FIG. 10 is a diagram illustrating a computer that executes a priority calculation program.

As illustrated in FIG. 10, a computer 300 includes a central processing unit (CPU) 310, a storage device 320 such as a hard disk drive (HDD), and a memory 340 such as a random-access memory (RAM). The units 300 to 340 are connected via a bus 400.

The storage device 320 stores therein in advance a priority calculation program 320a that functions as those of the acquisition unit 120, the calculation unit 121, and the output 122 described above. The priority calculation program 320a may also be appropriately divided.

The storage device 320 stores therein various types of information. For example, the storage device 320 includes an operation policy storage area 320b, a customer management information storage area 320c, an operation status information storage area 320d, and a priority information storage area 320e. The operation policy storage area 320b, the customer management information storage area 320c, the operation status information storage area 320d, and the priority information storage area 320e store the similar data as those of the operation policy storage area 110, the customer management information storage area 111, the operation status information storage area 112, and the priority information storage area 113 described above.

The CPU 310 functions as a priority calculation process 340a, by reading out a computer program from the priority calculation program 320a in the storage device 320, and executing it on the memory 340. The priority calculation process 340a executes the similar operations as those of the processing units in the embodiments, by appropriately reading various types of data from the storage device 320 and executing the processes. In other words, the priority calculation process 340a executes the operations similar to those of the acquisition unit 120, the calculation unit 121, and the output unit 122.

The priority calculation program 320a described above need not be stored in the storage device 320 from the beginning.

For example, computer programs may be stored in a “portable physical medium” such as a flexible disk (FD), a compact disc-read only memory (CD-ROM), a digital versatile disc (DVD), a magneto optical disk, an integrated circuit (IC) card, and the like that can be inserted into the computer 300. The computer 300 can read each program therefrom and execute it.

The computer programs may also be stored in “another computer (or server)” connected to the computer 300 via a public line, the Internet, a local area network (LAN), or a wide area network (WAN). The computer 300 can read each program therefrom and execute it.

According to an aspect of the present invention, it is possible to effectively deal with the problem.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device, comprising:
a calculation unit that calculates a priority for investigating each of a plurality of services based on a degree of influence on a client device that uses the plurality of services handed over from a first system to a second system in a cluster configuration and a degree of importance of each of the services, the plurality of services being divided into a plurality of nodes in a plurality of data centers and operated by the cluster configuration including the first system and the second system; and
an output unit that outputs the priority calculated by the calculation unit.

2. The information processing device according to claim 1, further comprising
an acquisition unit that acquires first information that indicates a response time between the client device and the nodes in the data centers, and second information that indicates a communication time between the nodes in the data centers; wherein
for each of the services, the calculation unit calculates a response time change rate from a response time between the client device and the node in the first system as well as a response time between the client device and the node in the second system, indicated in the first information; the calculation unit calculates downtime of the service from the communication time between the nodes in the first system and the second system, indicated in the second information; and the calculation unit calculates the degree of influence on the client device of the service, by using the response time change rate and the downtime of the service.

3. The information processing device according to claim 1, wherein for each of the services, the calculation unit calculates the degree of importance of the service from a priority level determined for the service, and a priority level determined for a provider of the service.

4. The information processing device according to claim 1, wherein the output unit outputs the degree of influence and the degree of importance, in correlation with the priority.

5. A non-transitory computer-readable recording medium having stored therein a program that causes a computer to execute a priority calculation process comprising:
calculating a priority for investigating each of a plurality of services based on a degree of influence on a client device that uses the plurality of services handed over from a first system to a second system in a cluster configuration and a degree of importance of each of the services, the plurality of services being divided into a plurality of nodes in a plurality of data centers and operated by the cluster configuration including the first system and the second system; and
outputting the calculated priority.

6. A data center system, comprising:
a plurality of nodes divided into a plurality of data centers and operated by a plurality of services in a first system and a second system in a cluster configuration; and
an information processing device that includes a calculation unit that calculates a priority for investigating each of the of services, based on a degree of influence on a client device that uses the plurality of services handed over from the first system to the second system and a degree of importance of each of the services, and an output unit that outputs the priority calculated by the calculation unit.
